(19) United States
(12) Patent Application Publication
(10) Pub. No.: US 2022/0402126 A1
(43) Pub. Date: Dec. 22, 2022

(54) SYSTEMS, COMPUTER PROGRAM PRODUCTS, AND METHODS FOR BUILDING SIMULATED WORLDS

(71) Applicant: Sanctuary Cognitive Systems Corporation, Vancouver (CA)

(72) Inventor: Suzanne Gildert, Vancouver (CA)

(21) Appl. No.: 17/846,243

(22) Filed: Jun. 22, 2022

Related U.S. Application Data
(60) Provisional application No. 63/213,385, filed on Jun. 22, 2021.

(51) Int. Cl. B25J 9/16

(52) U.S. Cl. CPC B25J 9/1605; B25J 9/1689

(57) ABSTRACT

Systems, computer program products, and methods for constructing models and simulations of real-world environments are described. A robot employs various sensors to collect data from its environment and provides this data to a tele-operation system. Any number of tele-artists may access the tele-operation system and use the robot sensor data to collaboratively construct a simulated scene representative of the robot's environment. The tele-artists may continue to update the simulation in real-time as the robot explores its environment and provides more sensor data. The robot may use the simulation in support of fundamental operations through its cognitive architecture, such as action planning and hypothesis generation.

An artificial intelligence controller of the robot may monitor the adaptations made to the simulation by the tele-artists in response to the sensor data in order to learn (e.g., via reinforcement learning) how to autonomously generate and update its own simulation based on its own sensor data.

### BACKGROUND

### Technical Field

The present systems, computer program products, and methods generally relate to constructing simulated worlds and particularly relate to enabling a robot to autonomously construct models of its external environment.

### Description of the Related Art

Robots are machines that may be deployed to perform work. Robots may come in a variety of different form factors, including humanoid form factors. Humanoid robots may be operated by tele-operation in which the robot is caused to emulate the physical actions of a human operator or pilot; however, such tele-operation systems typically require very elaborate and complicated interfaces comprising sophisticated sensors and equipment worn by or otherwise directed towards the pilot, thus requiring that the pilot devote their full attention to the tele-operation of the robot and limiting the overall accessibility of the technology.

Robots may be trained or otherwise programmed to operate semi-autonomously or fully autonomously. Training a robot typically involves causing the robot to repeatedly perform a physical task in the real world, which can cause significant wear and tear on the components of the robot before the robot can even be deployed to perform work in the field.

### BRIEF SUMMARY

A method of updating a simulation of an external environment of an agent by a tele-operation system may be summarized as including: displaying a simulation of the external environment of the agent to at least one user of the tele-operation system, the at least one user being physically remote from the agent; receiving data collected by at least one sensor of the agent; providing the data collected by at least one sensor of the agent to the at least one user of the tele-operation system; receiving simulation instructions from the at least one user of the tele-operation system, the simulation instructions based at least in part on the data collected by at least one sensor of the agent; updating the simulation of the external environment based on the simulation instructions; and displaying the updated simulation of the external environment to the at least one user of the tele-operation system.

Receiving simulation instructions from the at least one user of the tele-operation system may include receiving instructions that describe a modification to the simulation of the external environment. Updating the simulation of the external environment based on the simulation instructions may include applying the modification to the simulation of the external environment to cause the simulation of the external environment to more closely match a reality of the external environment. Receiving instructions that describe a modification to the simulation of the external environment may include receiving instructions that describe a modification to at least one object representation in the simulation of the external environment. Updating the simulation of the external environment based on the simulation instructions may include applying the modification to at least one object representation in the simulation of the external environment to cause the at least one object representation to more closely resemble a corresponding real-world counterpart object in the external environment.

Receiving simulation instructions from the at least one user of the tele-operation system may include receiving instructions that describe a new object representation for the simulation of the external environment. Updating the simulation of the external environment based on the simulation instructions may include applying the simulation instructions to add the new object representation to the simulation of the external environment, the new object representation corresponding to a real-world counterpart in the external environment characterized, at least in part, by the data collected by at least one sensor of the agent.

The method may further include: providing additional data collected by at least one sensor of the agent to the at least one user of the tele-operation system; receiving additional simulation instructions from the at least one user of the tele-operation system; re-updating the simulation of the external environment based on the additional simulation instructions; and displaying the re-updated simulation of the external environment to the at least one user of the tele-operation system.

The agent may include a robot system including a robot body and the at least one sensor of the agent may include at least one image sensor on-board the robot body. Displaying a simulation of the external environment of the agent to at least one user of the tele-operation system may include displaying a simulation of the external environment of the robot body to at least one user of the tele-operation system. Receiving data collected by at least one sensor of the agent may include receiving data collected by at least one image sensor of the robot body. Providing the data collected by at least one sensor of the agent to the at least one user of the tele-operation system may include providing the data collected by at least one image sensor of the robot body to the at least one user of the tele-operation system. The method may further include: training the robot system to autonomously update the simulation of the external environment based on multiple iterations of: the receiving data collected by at least one image sensor of the robot body; the providing the data collected by at least one image sensor of the robot body to the at least one user of the tele-operation system the receiving simulation instructions from the at least one user of the tele-operation system based at least in part on the data collected by at least one image sensor of the robot body; and the updating the simulation of the external environment based on the simulation instructions. The at least one user of the tele-operation system may include at least one tele-operator of the robot system.

The at least one user of the tele-operation system includes a plurality of tele-artists and the tele-operation system enables the plurality of tele-artists to concurrently update the simulation.

A tele-operation system may be summarized as including: at least one processor; and at least one non-transitory processor-readable storage medium communicatively coupled to the at least one processor, the at least one non-transitory processor-readable storage medium storing data and/or processor-executable instructions that, when executed by the at least one processor, cause the tele-operation system to: display a simulation of an external environment of an agent to at least one user of the tele-operation system, the at least one user being physically remote from the agent; receive data collected by at least one sensor of the agent; provide the data collected by at least one sensor of the agent to the at least one user of the tele-operation system; receive simulation instructions from the at least one user of the tele-operation system based at least in part on the data collected by at least one sensor of the agent; update the simulation of the external environment based on the simulation instructions; and display the updated simulation of the external environment to the at least one user of the tele-operation system.

The processor-executable instructions that, when executed by the at least one processor, cause the tele-operation system to receive simulation instructions from the at least one user of the tele-operation system, may cause the tele-operation system to receive instructions that describe a modification to the simulation of the external environment. The processor-executable instructions that, when executed by the at least one processor, cause the tele-operation system to update the simulation of the external environment based on the simulation instructions, may cause the tele-operation system to apply the modification to the simulation of the external environment to cause the simulation of the external environment to more closely match a reality of the external environment.

The processor-executable instructions that, when executed by the at least one processor, cause the tele-operation system to receive simulation instructions from the at least one user of the tele-operation system, may cause the tele-operation system to receive instructions that describe a modification to at least one object representation in the simulation of the external environment. The processor-executable instructions that, when executed by the at least one processor, cause the tele-operation system to update the simulation of the external environment based on the simulation instructions, may cause the tele-operation system to apply the modification to at least one object representation in the simulation of the external environment to cause the at least one object representation to more closely resemble a corresponding real-world counterpart object in the external environment.

The agent may include a robot system including a robot body, and the at least one sensor of the agent may include at least one image sensor on-board the robot body. The tele-operation system may further include: data and/or processor-executable instructions stored in the non-transitory processor-readable storage medium that, when executed by the at least one processor, cause the tele-operation system to: train the robot system to autonomously update to the simulation of the external environment based on multiple iterations of: receiving simulation instructions from the at least one user of the tele-operation system based at least in part on the data collected by at least one image sensor of the robot body; and updating the simulation of the external environment based on the simulation instructions.

The at least one user of the tele-operation system may include a plurality of tele-artists and the tele-operation system enables the plurality of tele-artists to concurrently update the simulation.

A computer program product may be summarized as including data and/or processor-executable instructions stored in a non-transitory processor-readable storage medium, the data and/or processor-executable instructions which, when the non-transitory processor-readable storage medium is communicatively coupled to at least one processor of a tele-operation system and the at least one processor executes the data and/or processor-executable instructions, cause the tele-operation system to: display a simulation of an external environment of an agent to at least one user of the tele-operation system, the at least one user being physically remote from the agent; receive data collected by at least one sensor of the agent; provide the data collected by at least one sensor of the agent to the at least one user of the tele-operation system; receive simulation instructions from the at least one user of the tele-operation system based at least in part on the data collected by at least one sensor of the agent; update the simulation of the external environment based on the simulation instructions; and display the updated simulation of the external environment to the at least one user of the tele-operation system. The at least one user of the tele-operation system may include a plurality of tele-artists and the computer program product may enable the plurality of tele-artists to concurrently update the simulation through the tele-operation system. The agent may include a robot system including a robot body and the at least one sensor of the agent may include at least one image sensor on-board the robot body. The computer program product may further include: data and/or processor-executable instructions which, when the non-transitory processor-readable storage medium is communicatively coupled to at least one processor of a tele-operation system and the at least one processor executes the data and/or processor-executable instructions, cause the tele-operation system to: train the robot system to autonomously update the simulation of the external environment based on multiple iterations of: receiving simulation instructions from the at least one user of the tele-operation system based at least in part on the data collected by at least one image sensor of the robot body; and updating the simulation of the external environment based on the simulation instructions.

A method of updating, by a robot system including a robot body, a simulation of an external environment of the robot body, may be summarized as including: loading a simulation of an external environment of the robot body; providing data collected by at least one sensor on-board the robot body to a tele-operation system that is physically remote from the robot body; receiving simulation instructions from the tele-operation system; and updating the simulation of the external environment based on the simulation instructions.

The method may further include training an artificial intelligence to autonomously update the simulation based at least in part on data collected by at least one sensor on-board the robot body. The method may further include storing the artificial intelligence in a non-transitory processor-readable storage memory on-board the robot body. Training an artificial intelligence to autonomously update the simulation based at least in part on data collected by at least one sensor on-board the robot body may include defining an objective function that updates the simulation to minimize discrepancies between the simulation and the data collected by at least one sensor on-board the robot body and optimizing the objective function by the robot system.

The method may further include: training the robot system to autonomously update the simulation of the external environment based on multiple iterations of: providing data collected by at least one sensor on-board the robot body to a tele-operation system that is physically remote from the robot body; receiving simulation instructions from the tele-operation system; and updating the simulation of the external environment based on the simulation instructions.

Receiving simulation instructions from the tele-operation system may include receiving instructions that describe a modification to the simulation of the external environment. Updating the simulation of the external environment based on the simulation instructions may include applying the modification to the simulation of the external environment to cause the simulation of the external environment to more closely match a reality of the external environment. Receiving instructions that describe a modification to the simulation of the external environment may include receiving instructions that describe a modification to at least one object representation in the simulation of the external environment. Updating the simulation of the external environment based on the simulation instructions may include applying the modification to at least one object representation in the simulation of the external environment to cause the at least one object representation to more closely resemble a corresponding real-world counterpart object in the external environment.

Receiving simulation instructions from the tele-operation system may include receiving instructions that describe a new object representation for the simulation of the external environment. Updating the simulation of the external environment based on the simulation instructions may include applying the simulation instructions to add the new object representation to the simulation of the external environment, the new object representation corresponding to a real-world counterpart in the external environment characterized, at least in part, by the data collected by at least one sensor on-board the robot body.

The method may further include: providing additional data collected by at least one sensor on-board the robot body to the tele-operation system; receiving additional simulation instructions from the tele-operation system; and re-updating the simulation of the external environment based on the additional simulation instructions.

A robot system may be summarized as including: a robot body; at least one sensor carried by the robot body; at least one processor; and at least one non-transitory processor-readable storage medium communicatively coupled to the at least one processor, the at least one non-transitory processor-readable storage medium storing data and/or processor-executable instructions that, when executed by the at least one processor, cause the robot system to: load a simulation of an external environment of the robot body; provide data collected by at least one sensor on-board the robot body to a tele-operation system that is physically remote from the robot body; receive simulation instructions from the tele-operation system; and update the simulation of the external environment based on the simulation instructions.

The robot system may further include: data and/or processor-executable instructions stored in the at least one non-transitory processor-readable storage medium that, when executed by the at least one processor, cause the robot system to train an artificial intelligence to autonomously update the simulation based at least in part on data collected by at least one sensor of the robot body. The data and/or processor-executable instructions that, when executed by the at least one processor, cause the robot system to train an artificial intelligence to autonomously update the simulation based at least in part on data collected by at least one sensor of the robot body, may cause the robot system to define an objective function that updates the simulation to minimize discrepancies between the simulation and the data collected by at least one sensor of the robot body and optimize the objective function.

The robot system may further include: data and/or processor-executable instructions stored in the at least one non-transitory processor-readable storage medium that, when executed by the at least one processor, cause the robot system to: train the robot system to autonomously update the simulation of the external environment based on multiple iterations of: providing data collected by at least one sensor of the robot body to a tele-operation system that is physically remote from the robot body; receiving simulation instructions from the tele-operation system; and updating the simulation of the external environment based on the simulation instructions.

The simulation instructions received from the tele-operation system may describe a modification to the simulation of the external environment. The data and/or processor-executable instructions that, when executed by the at least one processor, cause the robot system to update the simulation of the external environment based on the simulation instructions, may cause the robot system to apply the modification to the simulation of the external environment to cause the simulation of the external environment to more closely match a reality of the external environment.

The simulation instructions received from the tele-operation system may describe a modification to at least one object representation in the simulation of the external environment. The data and/or processor-executable instructions that, when executed by the at least one processor, cause the robot system to update the simulation of the external environment based on the simulation instructions, may cause the robot system to apply the modification to at least one object representation in the simulation of the external environment to cause the at least one object representation to more closely resemble a corresponding real-world counterpart object in the external environment.

Receiving simulation instructions from the tele-operation system may include receiving instructions that describe a new object representation for the simulation of the external environment. Updating the simulation of the external environment based on the simulation instructions may include applying the simulation instructions to add the new object representation to the simulation of the external environment, the new object representation corresponding to a real-world counterpart in the external environment characterized, at least in part, by the data collected by at least one sensor on-board the robot body.

The robot system may further include: data and/or processor-executable instructions stored in the at least one non-transitory processor-readable storage medium that, when executed by the at least one processor, cause the robot system to: provide additional data collected by at least one sensor of the robot body to the tele-operation system; receive additional simulation instructions from the tele-operation system; and re-updating the simulation of the external environment based on the additional simulation instructions.

A computer program product may be summarized as including: data and/or processor-executable instructions stored in a non-transitory processor-readable storage medium, the data and/or processor-executable instructions which, when the non-transitory processor-readable storage medium is communicatively coupled to at least one processor of a robot system and the at least one processor executes the data and/or processor-executable instructions, cause the robot system to: load a simulation of an external environment of the robot body; provide data collected by at least one sensor on-board the robot body to a tele-operation system that is physically remote from the robot body; receive simulation instructions from the tele-operation system; and update the simulation of the external environment based on the simulation instructions.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a flow diagram showing an exemplary method of updating a simulation of an external environment of an agent by a tele-operation system in accordance with the present systems, computer program products, and methods.

FIG. 2 is a flow diagram showing an exemplary method of operating a tele-operation system to train a robot system to autonomously update a simulation of an external environment of its robot body in accordance with the present systems, computer program products, and methods.

FIG. 3 is a flow diagram showing an exemplary method of updating a simulation of an external environment of a robot body by a robot system in accordance with the present systems, computer program products, and methods.

FIG. 4 is an illustrative diagram showing an example of collaborative simulation construction (or scene-building) between multiple tele-artists and a robot AI in accordance with the present systems, computer program products, and methods.

FIG. 5 is an illustrative diagram of an exemplary robot system communicatively coupled to a tele-operation system each comprising various features and components described throughout the present systems, methods and computer program products.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, computer program products, and methods.

The various embodiments described herein provide systems, computer program products, and methods for constructing and updating models of simulated worlds, for training robots to autonomously construct and update models of their own external environments, and for trained robots that autonomously perform such model construction and updating.

The present systems, computer program products, and methods may employ or include any/all of the teachings (including, without limitation, tele-operation systems and robots) from any of the following US patent applications, each of which is incorporated herein by reference in its entirety: U.S. Provisional Patent Application Ser. No. 63/151,044 (now U.S. Non-Provisional patent application Ser. No. 17/566,589), U.S. Provisional Patent Application Ser. No. 63/173,670 (now U.S. Non-Provisional patent application Ser. No. 17/719,110), U.S. Provisional Patent Application Ser. No. 63/184,268 (now U.S. Non-Provisional patent application Ser. No. 17/737,072), and U.S. Provisional Patent Application Ser. No. 63/351,274 (collectively, the “Incorporated Patent Applications”).

As described in the Incorporated Patent Applications, a robot may include sensors that detect various parameters of the robot's external environment. Exemplary sensors include, without limitation: optical sensors, cameras, depth sensors, LIDAR, sonar, audio sensors, microphones, tactile sensors, haptic sensors, and so on (collectively, “Sensors”). In accordance with the present systems, computer program products, and methods, data collected by a robot's Sensors may be employed to construct a model of the robot's external environment, and such model may take the form of a simulated world in which a simulation of the robot itself exists and operates. In some implementations, this simulated world model may be employed or otherwise leveraged by the robot's control system to support action planning, goal setting, hypothesis generation, task performance, and general robot operation.

More generally, implementations of the present systems, computer program products, and methods are not limited to robots or use with robots and can be applied broadly in any application involving an agent. That is, the present systems, methods, and computer program products may be used in, or make use of, any agent (including but not limited to a robot system as an agent) where the agent serves as a device or entity for carrying out and/or embodying the various implementations described herein. Exemplary agents include, but are not limited to: robots, robot systems, vehicles (e.g., car, trucks, boats, planes, trains, and so on), machines, video game characters (playable or non-playable), users of various devices products such as video game controllers and/or AR/VR equipment, and so on.

Data collected by an agent's Sensors may be employed (either directly or indirectly as output form one or more feature extractor(s) making use of the data) to construct or update a model of the agent's external environment, either: i) manually by one or more user(s) or operator(s); ii) automatically by the agent itself; or iii) by some combination of manually by one or more user(s) or operator(s) and automatically by the agent.

As further described in the Incorporated Patent Applications, an agent (e.g., a robot system) may be tele-operated in real-time by a tele-operation system that may include one or more pilot(s). Control instructions and other operational details provided by one or more tele-operator(s) may be monitored and used to train an artificial intelligence to autonomously operate or control the agent. In accordance with the present systems, computer program products, and methods, a tele-operation system may be adapted for use in constructing and/or updating models of an agent's (e.g., a robot's) external environment and used to train an artificial intelligence to autonomously construct and/or update models of an agent's (e.g., a robot's) external environment.

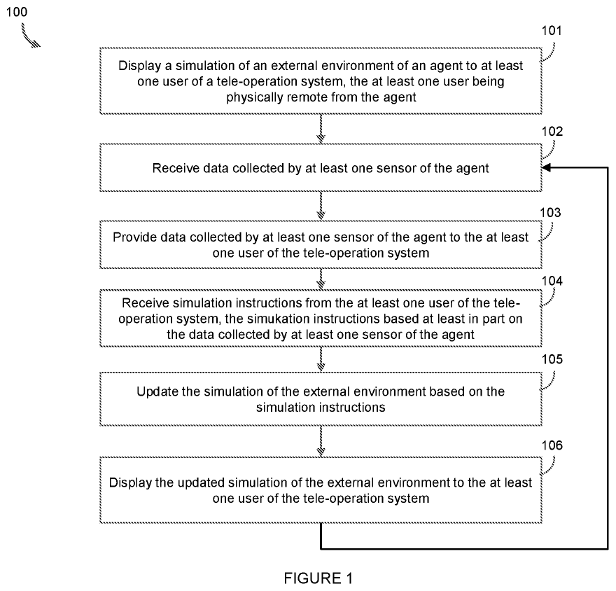

FIG. 1 is a flow diagram showing an exemplary method 100 of constructing and/or updating a simulation of an external environment of an agent by a teleoperation system in accordance with the present systems, computer program products, and methods. Method 100 includes six acts 101, 102, 103, 104, 105, and 106, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 101, a tele-operation system displays (e.g., on at least one display or monitor) a simulation or model of an external environment of the agent to at least one user of the tele-operation system. As will be described in more detail later on, a user of a tele-operation system may include, but is not limited to, a tele-operator, a pilot, and/or a tele-artist. Initially, in some implementations, the simulation or model may be very basic and include little to no detail that corresponds to the actual external environment of the agent. For example, initially the simulation displayed at 101 may consist of a simulation of the agent floating in free space, or a simulation of the agent positioned on a basic representation of a ground or floor. In some implementations, the simulation displayed at 101 may include a template environment selected, e.g., by at least one user of the tele-operation system, based on some initial data or information. For example, if the agent is known to be deployed indoors, then the simulation initially displayed at 101 may include walls and a ceiling.

At 102, the tele-operation system receives data collected by at least one sensor (e.g., any number of Sensors) of the agent. The data may be received via a wired connection or tether, or wirelessly via any manner of wireless signal propagation and/or utilizing any wireless communication protocol, such as 3G, LTE, 4G, 5G, Bluetooth, Zigbee, and the like.

At 103, the tele-operation system provides the data collected by at least one sensor (e.g., Sensors) of the agent (received at 102) to the at least one user of the tele-operation system. In some implementations, at least some data collected by the agent (e.g., visual data such as camera data) may be displayed by the tele-operation system to the at least one user. Thus, in some implementations, the at least one user of the tele-operation system may receive dual display data from the tele-operation system: a first display at 101 of the current state of the simulation and, in parallel, a second display at 103 of real-time data (e.g., visual data) collected by Sensors of the agent.

At 104, the tele-operation system receives simulation instructions from the at least one user of the tele-operation system, e.g., through a communication or network interface. The simulation instructions may be based, at least in part, on the data collected by at least one sensor of the agent. The simulation instructions may describe at least one of: i) a modification to the simulation of the external environment of the agent (e.g., a change or modification to at least one object representation in the simulation of the agent's external environment, such as a displacement, rotation, re-orientation, deletion, addition, subtraction, conversion, re-coloration, re-texturization, re-shaping, or other change to the at least one object representation); and/or ii) an addition to the simulation of the external environment of the agent (e.g., an introduction of a new object in the agent's external environment). For example, if the data provided at 103 is understood by the at least one user of the tele-operation system to indicate that there is a particular object located at a particular position in the agent's external environment (e.g., a table at location X, a tree at location Y, a door at location Z, and so on), then the at least one user of the tele-operation may define simulation instructions that instruct the tele-operation system to add a simulation of the particular object (i.e., an object representation) to the corresponding particular location in the simulation of the agent's environment, and at 104 such simulation instructions are received by the tele-operation system.

At 105, the tele-operation system updates the simulation of the external environment of the agent. The updated simulation may include a modification and/or addition to the simulation described or defined in the simulation instructions received from the at least one user of the tele-operation. For example, if the simulation instructions received by the tele-operation system at 104 instruct the tele-operation system to add a simulation of a particular object to a particular location in the simulation of the agent's environment, then at 105 the tele-operation system updates the simulation to include the particular object at the particular location in the simulation. Generally, if the simulation instructions received by the tele-operation system at 104 include or describe a modification to the simulation, then when the tele-operation system updates the simulation at 105 the tele-operation system may apply the modification to the simulation of the external environment to cause the simulation of the external environment to more closely match a reality of the agent's external environment. For example, if the simulation instructions received by the tele-operation system at 104 include or describe a modification to at least one object representation in the simulation of the external environment, then when the tele-operation system updates the simulation at 105 the tele-operation system may apply the modification to at least one object representation in the simulation of the external environment to cause the at least one object representation to more closely resemble a corresponding real-world counterpart object in the agent's external environment. Similarly, if the simulation instructions received by the tele-operation system at 104 include or describe a new object representation for (i.e., to be added to) the simulation of the external environment, then when the tele-operation system updates the simulation at 105 the tele-operation system may apply the simulation instructions to add the new object representation to the simulation of the external environment, the new object representation corresponding to a real-world counterpart in the external environment characterized, at least in part, by the data collected by at least one sensor of the agent at 102.

At 106, the tele-operation system displays the updated simulation generated at 105 to the at least one user of the tele-operation system. In this way, the at least one user of the tele-operation system applies updates to the simulation of the agent's external environment through the tele-operation system (at 105) in real-time while the at least one user of the tele-operation system perceives the agent's external environment through the tele-operation system using data collected by Sensors of the agent (at 102 and 103).

If the simulation of the agent's external environment is sufficiently complete after the update applied at 105 (e.g., if the boundaries and/or all of the objects in the agent's environment are sufficiently represented in the simulation as judged, e.g., by the at least one user of the tele-operation system, by the tele-operation system itself, and/or by the agent) then method 100 ends after one iteration of acts 102, 103, 104, 105, and 106. Generally, a simple and static environment may be characterized through one iteration of acts 102, 103, 104, 105, and 106; however, in some implementations, such as implementations in which the agent's external environment comprises multiple detailed objects and/or complex boundaries, and/or in implementations in which the agent's external environment is dynamically changing (e.g., the agent is operating in a free, open, or uncontrolled environment), then acts 102, 103, 104, 105, and 106 of method 100 may be repeated for any number of additional iterations in order to keep the simulation up-to-date in real-time. In this way, if and when the agent's external environment changes (due, for example, to the agent transitioning into a new environment or due to a change in or introduction of any object in the agent's environment) then continued reiteration of acts 102, 103, 104, 105, and 106 of method 100 enables the tele-operation system (and the at least one user of the tele-operation system, and the agent itself) to maintain an up-to-date simulation of the external environment in real-time.

In some implementations, the tele-operation system may include world-building (or scene-building) software that the at least one user of the tele-operation system may use or employ to define and provide simulation instructions to the tele-operation system (e.g., at 104). Examples of suitable world-building or scene-building software include any one or combination of: Unreal Engine (e.g., UE4), Blender, Houdini, and Nvidia Omniverse. In some implementations, the world-building or scene-building software deployed in the tele-operation system may advantageously allow physical properties and physics to be defined.

In accordance with the present systems, computer program products, and methods, at least one user of the tele-operation system may use the tele-operation system to define and refine a simulation or model of the external environment of the agent in real-time based on observations or data collected by Sensors of the agent. In some implementations, this same at least one user of the tele-operation system may use the tele-operation system to control the operation of the agent (e.g., when the agent is or includes a robot system or an autonomous vehicle, as examples); however, in other implementations a first user of the tele-operation system (or a first set of users of the tele-operation system) may use the tele-operation system to control the operation of the agent while a second user of the tele-operation system (or a second set of users of the tele-operation system) may use the tele-operation system to define and refine the simulation in accordance with method 100. Thus, in some implementations, the at least one user of the tele-operation described in method 100 may not actually contribute to the operation of the agent. In implementations where at least one user of the tele-operation system defines and refines the simulation but does not operate (or contribute to the operation of) the agent, such a user of the tele-operation system may be referred to as a “tele-artist”.

In some implementations of method 100, the at least one user of the tele-operation system may consist of a single tele-operator or a single tele-artist; however, in other implementations of method 100 the at least one user of the tele-operation system may comprise multiple tele-operators and/or multiple tele-artists all active in the simulation at the same time. For example, the tele-operation system may store and run a simulation of the agent's external environment, display this simulation to multiple tele-operators/tele-artists concurrently at 101, provide agent Sensor data (e.g., a dual display of the agent's view of the world) to the multiple tele-operators/tele-artists concurrently at 103, receive simulation instructions from any number of the multiple tele-operators/tele-artists concurrently at 104, update, at 105, the simulation based on all of the simulation instructions received at 104, and display the updated simulation to the multiple tele-operators/tele-artists concurrently at 106. In this way, the real-time construction of a model or simulation of the agent's external environment may be a shared, collaborative endeavor performed concurrently in real-time by any number of tele-operators/tele-artists.

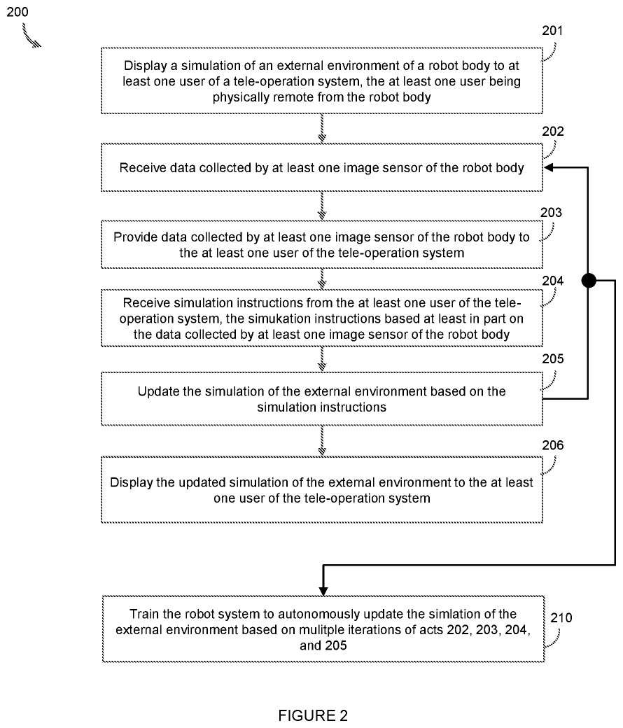

In some implementations, method 100 may be extended or adapted to train the agent to autonomously update the simulation of its external environment itself. A specific example of this in which the agent is a robot system is illustrated in FIG. 2, though a person of skill in the art will appreciate that agents other than robot systems may similarly be trained in accordance with method 200 of FIG. 2, including but not limited to: autonomous vehicles, video game characters (whether playable or non-playable), and autonomous machines.

FIG. 2 is a flow diagram showing an exemplary method 200 of training a robot system to autonomously update a simulation of its external environment in accordance with the present systems, computer program products, and methods. Method 200 includes seven acts 201, 202, 203, 204, 205, 206, and 210, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

Method 200 represents a specific implementation of method 100 from FIG. 1 in which the agent is a robot system and the at least one sensor includes an image sensor on-board the robot system. Method 200 further represents an extension or adaptation of method 100 from FIG. 1. Accordingly, method 200 includes all of the acts of method 100 with the agent specifically identified as a robot system.

At 201, a tele-operation system displays (e.g., on at least one display or monitor) a simulation or model of an external environment of the robot to at least one user of the tele-operation system in a similar way to that described at 101 of method 100.

At 202, the tele-operation system receives data collected by at least one image sensor of the robot in a similar way to that described at 102 of method 200.

At 203, the tele-operation system provides the data collected by at least one image sensor of the robot (received at 202) to the at least one user of the tele-operation system in a similar way to that described at 103 of method 100.

At 204, the tele-operation system receives simulation instructions from the at least one user of the tele-operation system, e.g., through a communication or network interface in a similar way to that described at 104 of method 100.

At 205, the tele-operation system updates the simulation of the external environment of the robot in a similar way to that described at 105 of method 100.

At 206, the tele-operation system displays the updated simulation generated at 205 to the at least one user of the tele-operation system in a similar way to that described at 106 of method 100.

As illustrated in FIG. 2, acts 202, 203, 204, and 205 (and optionally act 206) may be iterated multiple times. In each iteration, the tele-operation system receives data from the robot's at least one image sensor and applies an update to the simulation of the robot's environment based, at least in part, on this data. In this way, a process for determining updates to the simulation based on image data is implemented. In method 100, this process is a substantially manual process relying on input from at least one user of the tele-operation system; however, at 210, the teleoperation system trains the robot system to autonomously carry out this process to update the simulation of the external environment (i.e., the robot's external environment) itself. The “training data” in this case includes the data corresponding to multiple iterations of acts 202, 203, 204, and 205 (and optionally act 206).

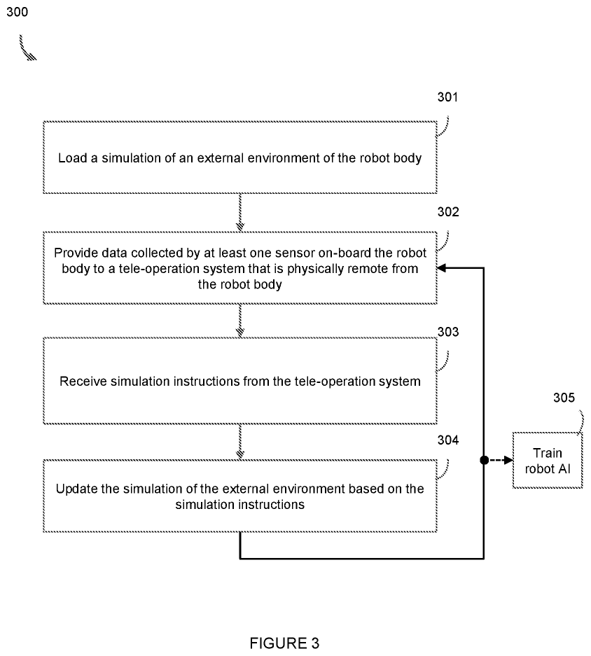

FIG. 3 is a flow diagram showing an exemplary method 300 of constructing and/or updating a simulation of an external environment of a robot body by a robot system, and training the robot system to do so autonomously, in accordance with the present systems, computer program products, and methods. Method 300 includes five acts 301, 302, 303, 304, and 305, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 301, the robot system loads or otherwise accesses a simulation or model of the external environment of the robot body. The model may be stored locally in a non-transitory processor-readable storage medium on-board the robot body or the model may be loaded/accessed remotely by the robot system through a communication or network interface. Initially the simulation loaded or accessed at 301 may be very basic, consisting of a representation of the robot body itself and few to no other features or characteristics. The initial simulation may include a representation of a ground or floor. In some implementations, the initial simulation loaded or accessed at 301 may include a template that is suitable for the robot body's current environment. For example, if the robot body is known to be indoors then the initial simulation may include walls and a ceiling, whereas if the robot body is known to be outdoors than the initial simulation may include a sky. The simulation loaded/accessed by the robot system at 301 may be provided by, or concurrently loaded or accessed by, a tele-operation system in communication with the robot system.

At 302, the robot system provides (e.g., via communication interface or network interface) data collected by Sensors on-board the robot body to the tele-operation system. Data collected by Sensors may include or provide details, features, and/or characteristics of the robot body's external environment (including details, features, and/or characteristics of objects located throughout the robot body's external environment) that may be added to the simulation loaded at 301.

At 303, the robot system receives (e.g., via a communication interface or network interface utilizing any wireless communication protocol, such as 3G, LTE, 4G, 5G, Bluetooth, Zigbee, and the like) simulation instructions from the tele-operation system. The simulation instructions may include or describe at least one of: i) a modification to the simulation of the external environment of the robot body (e.g., a change to at least one object in the robot body's external environment, such as a displacement, rotation, re-orientation, deletion, addition, subtraction, conversion, re-coloration, re-texturization, re-shaping, or other change to the at least one object representation); and/or ii) an addition to the simulation of the external environment of the robot body (e.g., an introduction of a new object in the robot body's external environment). The simulation instructions may originate at or from at least one tele-operator or tele-artist that is also in communication with the tele-operation system. The simulation instructions may be based, at least in part, on the data provided by the robot system to the tele-operation system at 302.

At 304, the robot system updates the simulation of the external environment based on the simulation instructions received at 303. For example, if the simulation instructions received at 303 indicate that a simulation of a couch should be positioned at a certain location in the simulation, then at 304 the robot system updates the simulation to include the simulation of the couch at the prescribed location in the simulation. Generally, if the simulation instructions received by the robot system at 303 include or describe a modification to the simulation, then when the robot system updates the simulation at 304 the robot system may apply the modification to the simulation of the external environment to cause the simulation of the external environment to more closely match a reality of the robot body's external environment. For example, if the simulation instructions received by the robot system at 303 include or describe a modification to at least one object representation in the simulation of the external environment, then when the robot system updates the simulation at 304 the robot system may apply the modification to at least one object representation in the simulation of the external environment to cause the at least one object representation to more closely resemble a corresponding real-world counterpart object in the robot body's external environment. Similarly, if the simulation instructions received by the robot system at 303 include or describe a new object representation for (i.e., to be added to) the simulation of the external environment, then when the robot system updates the simulation at 304 the robot system may apply the simulation instructions to add the new object representation to the simulation of the external environment, the new object representation corresponding to a real-world counterpart in the external environment characterized, at least in part, by the data collected by at least one sensor of the robot body at 302.

At 305, the robot system adapts, revises, refines, updates, or otherwise trains its control software or artificial intelligence based on, among other things, the processes carried out in acts 302, 303, and 304 in order to learn to construct and/or update its own simulation of its own body's external environment substantially autonomously. That is, in accordance with the present systems, computer program products, and methods, a robot's artificial intelligence may monitor the processes, actions, reactions, data, and instructions all involved in acts 302, 303, and 304 and learn to follow or implement similar processes in similar contexts. In some implementations, this learning may apply at least some of the principles of machine learning known as reinforcement learning. For example, if the robot's artificial intelligence monitors (at 305) that when the Sensor data provided at 302 is of a particular form or configuration then the simulation instructions provided at 303 generally indicate a particular update should be made to the simulation at 304 (e.g., Sensor data configuration X generally results in simulation instructions Y that specify a particular object Z should be introduced to the simulation or a particular modification AA should be applied to the simulation), then the artificial intelligence of the robot system may learn at 305 to reproduce this process such that if, at a subsequent instance of method 300, the Sensor data configuration provided at 302 is of a similar configuration (e.g., similar to configuration X) the robot system can autonomously generate simulation instructions (e.g., similar to instructions Y) at 303 to autonomously update the simulation (e.g., to introduce an instance of object Z or the modification AA) at 304.

If the simulation of the robot's external environment is sufficiently complete after the update applied at 304 (e.g., if the boundaries and/or all of the objects in the robot body's environment are sufficiently represented in the simulation as judged by, e.g., at least one tele-operator of the tele-operation system, and/or autonomously by the robot system itself) then method 300 may include only one iteration of acts 302, 303, 304, and 305. Generally, a simple and static environment may be characterized through one iteration of acts 302, 303, 304, and 305; however, in some implementations, such as implementations in which the robot body's external environment comprises multiple detailed objects and/or complex boundaries, and/or in implementations in which the robot body's external environment is dynamically changing (e.g., the robot body is operating in a free, open, or uncontrolled environment), then acts 302, 303, 304, and 305 of method 300 may be repeated for any number of additional iterations in order to keep the simulation up-to-date in real-time and to continue to train the robot system's artificial intelligence in the task of constructing and/or updating simulations/models/scenes of the robot body's environment. In this way, if and when the robot body's external environment changes (due, for example, to the robot body transitioning into a new environment or due to a change in or introduction of any object in the robot body's environment) then continued reiteration of acts 302, 303, 304, and 305 of method 300 may enable the tele-operation system (and at least one tele-operator and/or tele-artist, and the robot system itself) to maintain an up-to-date simulation of the external environment in real-time.

In some implementations, the robot system itself (or the artificial intelligence thereof) may provide Sensor data to a tele-operation system and then act as a spectator for the generation and application of simulation instructions, all the while the robot system may be learning what simulation instructions it itself should generate in response to Sensor data if it were acting autonomously. In some implementations, the robot system (or the artificial intelligence thereof) may collaborate with one or more tele-operators/tele-artists to build, construct, generate, update, and/or revise a simulation in real-time. In such implementations, both the robot system (or the artificial intelligence thereof) and the tele-operators/tele-artists may be able to edit, adapt, revise, construct, build, or otherwise update the simulation concurrently. In other words, the robot system itself (or the artificial intelligence thereof) may contribute to the simulation as a tele-artist and collaborate (and, e.g., learn from) other tele-artists engaged with the tele-operation system. Advantageously, the tele-operators/tele-artists may, in some implementations, have the authorization to review and approve/reject/revise contributions to the simulation made by the robot system (or the artificial intelligence thereof) in order to further train the artificial intelligence of the robot system in the task of scene-building. For example, if the Sensor data provided by the robot body clearly shows a chair located at position X and the robot system itself updates the simulation to provide a table at position X, at least one tele-operator or tele-artist may reject the robot system's update to the simulation and replace the robot system's update with a new update that correctly provides a chair at position X. The robot system (or the artificial intelligence thereof) may monitor this process and learn from the rejection and revision that, in subsequent instances of similar Sensor data, a chair should be deployed a position X in the simulation rather than a table.

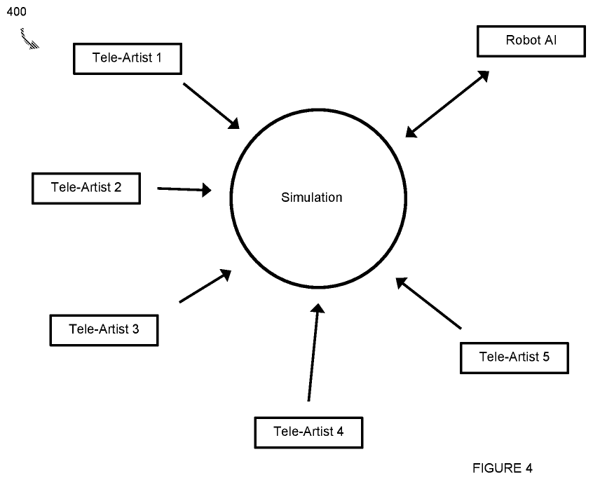

FIG. 4 is an illustrative diagram showing an example of collaborative simulation construction (or scene-building) 400 between multiple tele-artists and a robot AI in accordance with the present systems, computer program products, and methods. In the illustrated example of collaborative simulation construction 400, five tele-artists and one robot artificial intelligence all contribute to one simulation substantially concurrently; however, in accordance with the present systems, computer program products, and methods in alternative implementations any number of tele-artists (i.e., five, fewer than five, or more than five) and any number of robot AIs (i.e., one, fewer than one, or more than one) may concurrently contribute to any number of simulations (i.e., one or more than one). Collaborative simulation construction 400 shows five tele-artists contributing to one simulation via unidirectional arrows and one robot AI both contributing to and learning from the one simulation via a bidirectional arrow. That is, in collaborative simulation construction 400 the robot AI learns from the contributions of the five tele-artists to the simulation (including, in some implementations, revisions and/or corrections made to contributions by the robot AI to the simulation) to improve its performance in scene-building and ultimately achieve a level of autonomy such that the robot AI may independently and autonomously construct simulations of its external environment without guidance, oversight, or contribution from tele-operators and/or tele-artists.

In some implementations, a human tele-artist may construct a world or simulation based on Sensor data by comparing the Sensor data to the current state of the simulated world and updating the state of the simulated world to remove discrepancies between the Sensor data and the simulated world. For example, if the Sensor data indicates a door in a north-side wall of a room and a simulated instance of the room does not include such a door, then the door is a discrepancy between the Sensor data and the simulation and the tele-artist may eliminate the discrepancy by adding a simulated door (i.e., an object representation of a door object) in the simulated north-side wall of the simulated room. Thus, when a robot system (or artificial intelligence thereof) is trained to autonomously construct its own simulation of its external world, the robot system (or artificial intelligence thereof) may invoke a similar process whereby the robot system (or artificial intelligence thereof) defines an objective function that is optimized when discrepancies between the simulation and the Sensor data are minimized. That is, the robot system (or artificial intelligence thereof) may frequently, repeatedly, or continually monitor (e.g., at 305 of method 300) any differences or discrepancies between Sensor data (including outputs of feature extractors acting on such Sensor data) and simulation data and update the simulation to remove, eliminate, or minimize any such discrepancy in a persistent effort to bring the simulation into maximum alignment with the Sensor data and thereby optimize its objective function. A similar process of objective function optimization may be executed by the tele-operation system to train the robot system, e.g., per method 200.

In some implementations, tele-artists and/or robot AIs may generate simulation instructions by selecting, for example, template object representations (e.g., procedural objects) to add to the simulation from a menu of candidate object representations (e.g., from a generalized asset library) and then, if necessary, revising the selected template to at least approximately match the features of the actual object. For example, if the Sensor data depicts a car in the simulation, a tele-artist may generate simulation instructions to add a car to the simulation by selecting a car template from a list of object templates and then defining specific features of the particular car (such as shape, style, make, model, color, year, and so on) to improve the match between the template and the actual car depicted in the Sensor data. In some implementations, variational auto-encoders may be implemented to help an artificial intelligence of the robot system to substantially autonomously refine generalized procedural objects by defining/changing the parameters thereof to match Sensor data.

In accordance with the present systems, computer program products, and methods, a simulation may or may not run simulated physics. An example of a simulation that does not run simulated physics is a static simulation that does not evolve over time unless otherwise updated (e.g., by the robot system or tele-operation system). An example of a simulation that does run simulated physics is a dynamic simulation in which objects may move or otherwise evolve in deterministic ways based on Sensor data. For example, in some implementations simulation instructions (e.g., at 104 or 303) may include static parameters or features (such as size, geometry, color, and so on) and also dynamic parameters or features (such as velocity, speed, trajectory, various physical coefficients (elasticity, friction, expansion, and so on), and so on). In implementations in which simulation instructions include dynamic parameters or features, a simulation may run simulated physics to evolve the simulation over time in the absence of further updates from the robot system and/or tele-operation system. When tele-operators or tele-artists provide input into the system to influence the physics of the simulation, they may be serving as “tele-physicists”.

In accordance with the present systems, computer program products, and methods, a given simulation may be stored (e.g., by a robot system or by a tele-operation system) in a non-transitory processor-readable storage medium and re-accessed/re-loaded in the future. For example, if it is known or identified that a robot body is in an environment that it has been in before, then at 301 of method 300 the robot system may load an instance of a stored simulation that was previously constructed for that environment. Then, discrepancies between the stored instance of the simulation and the current instance of the simulation may be eliminated or minimized by one or more tele-artists and/or by the robot system itself as described previously.

In accordance with the present systems, computer program products, and methods, a simulation of a robot body's external environment may be employed by the robot system's fundamental control systems (e.g., cognitive architecture) in order to operate the robot system to perform various tasks and actions in the real-world that is represented by the simulation. For example, a simulation may be used by the robot system for task planning, hypothesis generation, action assessment, and so on; thus, the accuracy with which the simulation models the external environment (where fewer discrepancies corresponds to higher accuracy) is an important factor influencing the performance of the robot system in achieving in tasks.

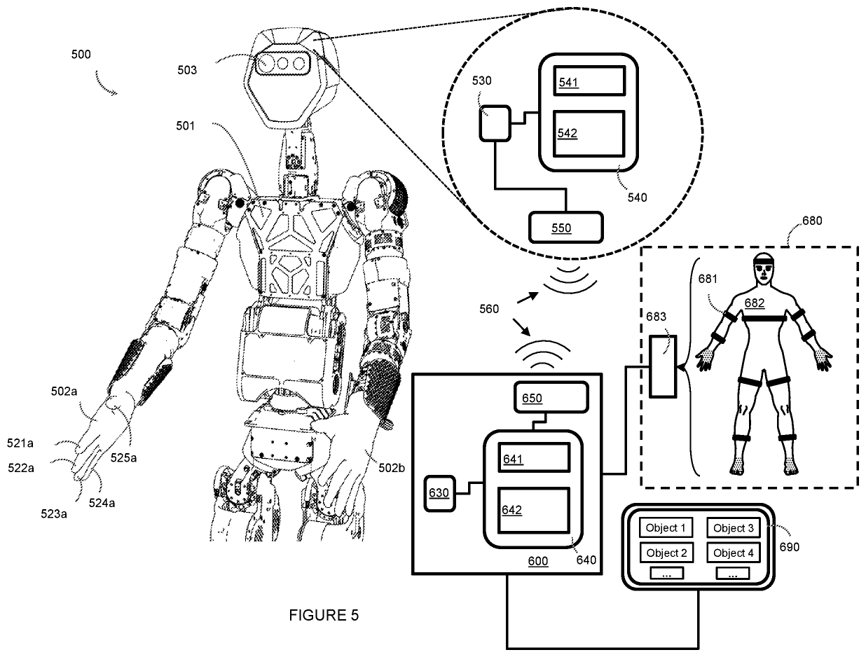

FIG. 5 is an illustrative diagram of an exemplary robot system 500 communicatively coupled to a tele-operation system 600 each comprising various features and components described throughout the present systems, methods and computer program products. Robot system 500 comprises a robot body 501 with a first physically actuatable component 502a and a second physically actuatable component 502b mechanically coupled to body 501. In the illustrated implementation, first and second physically actuatable components 502a and 502b each correspond to a respective robotic hand, though a person of skill in the art will appreciate that in alternative implementations a physically actuatable component may take on other forms (such as an arm or leg, a non-hand-like end effector such as a cutter or suction tube, or any other form useful to the particular applications the robot is intended to perform).

Robotic hand 502a emulates a human hand and includes multiple fingers 521a, 522a, 523a, and 524a and an opposable thumb 525a. Robotic hand 502b is similar to a mirror-image of robotic hand 502a while corresponding details are not labeled for robotic hand 502b to reduce clutter. Robotic hands 502a and 502b may be physically actuatable by a variety of different means, including electromechanical actuation, cable-driven actuation, magnetorheological fluid-based actuation, and/or hydraulic actuation. Some exemplary details of actuation technology that may be employed to physically actuate robotic hands 502a and 502b are described in U.S. patent application Ser. No. 17/491,577 and U.S. Provisional Patent Application Ser. No. 63/191,732, filed May 21, 2021 and entitled “Systems, Computer program products, And Methods For A Hydraulic Robotic Arm” (now U.S. Non-Provisional patent application Ser. No. 17/749,536), both of which are incorporated by reference herein in their entirety.

Robot body 501 further includes at least one sensor 503 that detects and/or collects data about the environment and/or objects in the environment of robot system 500. In the illustrated implementation, sensor 503 corresponds to a sensor system including a camera, a microphone, and an initial measurement unit that itself comprises three orthogonal accelerometers, a magnetometer, and a compass.

For the purposes of illustration, FIG. 5 includes details of certain exemplary components that are carried by or within robot body 501 in accordance with the present systems, methods, and computer program products. Such components include at least one processor 530 and at least one non-transitory processor-readable storage medium, or “memory”, 540 communicatively coupled to processor 530. Memory 540 stores simulation data (e.g., a library of object representations, a renderer, and so on) 541 and processor-executable instructions 542 that, when executed by processor 530, cause robot system 500 to construct and/or update a simulation of an external environment of robot body 501 in accordance with method 300. In some implementations, data 541 and instructions 542 may together be referred to as a computer program product that, when loaded or stored in memory 540 of robot system 500 and executed by processor 530 cause robot system 500 to carry out method 300 described herein.

Processor 530 is also communicatively coupled to a wireless transceiver 550 via which robot body 501 sends and receives wireless communication signals 560 with an exemplary teleoperation system 600. To this end, teleoperation system 600 also includes a wireless transceiver 650 communicatively coupled with at least one processor 630. Tele-operation system 600 also includes a non-transitory processor-readable storage medium or “memory” 640 that stores simulation data 641 (e.g., a library of object representations, a renderer, and the like) and processor-executable instructions 642 that, when executed by processor 630, cause tele-operation system 600 to carry out method 100 and/or method 200 as described herein. In some implementations, the combination of data 641 and instructions 642 may be referred to as a computer program product that, when loaded in or stored on memory 640 of teleoperation system 640 and executed by processor 630, cause tele-operation system 600 to execute methods 100 and/or 200.

A person of skill in the art will appreciate that while FIG. 5 illustrates both a computer program product comprising data 541 and instructions 542 on-board robot body 501 to cause robot system 500 to perform method 300 and a computer program product comprising data 641 and instructions 642 on-board tele-operation system 600 to cause tele-operation system 600 to perform methods 100 and/or 200 such is included for completeness only and in some implementations only one of robot system 500 and/or tele-operation system 600 may store a deploy a corresponding computer program product in accordance with the present systems, computer program products, and methods.

For the purposes of illustration, teleoperation system 600 includes both a low-level teleoperation interface 680 and a high-level teleoperation interface 690. Low-level teleoperation interface 680 includes a sensor system 681 that detects real physical actions performed by a human tele-operator or pilot 682 and a processing system 683 that converts such real physical actions into low-level teleoperation instructions that, when executed by processor 530, cause robot body 501 (and any applicable actuatable components such as hands 502a and/or 502b) to emulate the physical actions performed by pilot 682. In some implementations, sensor system 681 may include many sensory components typically employed in the field of virtual reality games, such as haptic gloves, accelerometer-based sensors worn on the body of pilot 682, and a VR headset that enables pilot 682 to see optical data collected by sensor 503 of robot body 501. High-level teleoperation interface 690 includes a simple GUI displayed, in this exemplary implementation, on a tablet computer. The GUI of high-level teleoperation interface 690 provides a set of buttons each corresponding to a respective object representation or simulation task selectable and/or deployable by a tele-artist. Object(s) selected by a user/artist of high-level teleoperation interface 690 through the GUI are converted into high-level instructions that, when executed by processor 630, cause tele-operation system 600 to apply corresponding updates to the simulation of the external environment of robot body 501 per methods 100 and 200.

The robots described herein may, in some implementations, employ any of the teachings of U.S. patent application Ser. No. 16/940,566, U.S. patent application Ser. No. 17/023,929, U.S. patent application Ser. No. 17/061,187, U.S. patent application Ser. No. 17/098,716, U.S. patent application Ser. No. 17/111,789, U.S. patent application Ser. No. 17/158,244, U.S. Provisional Patent Application Ser. No. 63/001,755 (now U.S. Non-Provisional patent application Ser. No. 17/217,650), U.S. Provisional Patent Application Ser. No. 63/057,461 (now U.S. Non-Provisional patent application Ser. No. 17/386,877), and/or U.S. Provisional Patent Application Ser. No. 63/086,258 (now U.S. Non-Provisional patent application Ser. No. 17/491,577), each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, computer program products, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method of updating a simulation of an external environment of an agent by a tele-operation system, the method comprising:
displaying a simulation of the external environment of the agent to at least one user of the tele-operation system, the at least one user being physically remote from the agent;
receiving data collected by at least one sensor of the agent;
providing the data collected by at least one sensor of the agent to the at least one user of the tele-operation system;
receiving simulation instructions from the at least one user of the tele-operation system, the simulation instructions based at least in part on the data collected by at least one sensor of the agent;
updating the simulation of the external environment based on the simulation instructions; and
displaying the updated simulation of the external environment to the at least one user of the tele-operation system.

2. The method of claim 1 wherein receiving simulation instructions from the at least one user of the tele-operation system includes receiving instructions that describe a modification to the simulation of the external environment.

3. The method of claim 2 wherein updating the simulation of the external environment based on the simulation instructions includes applying the modification to the simulation of the external environment to cause the simulation of the external environment to more closely match a reality of the external environment.

4. The method of claim 2 wherein receiving instructions that describe a modification to the simulation of the external environment includes receiving instructions that describe a modification to at least one object representation in the simulation of the external environment.

5. The method of claim 4 wherein updating the simulation of the external environment based on the simulation instructions includes applying the modification to at least one object representation in the simulation of the external environment to cause the at least one object representation to more closely resemble a corresponding real-world counterpart object in the external environment.

6. The method of claim 1 wherein receiving simulation instructions from the at least one user of the tele-operation system includes receiving instructions that describe a new object representation for the simulation of the external environment, and wherein updating the simulation of the external environment based on the simulation instructions includes applying the simulation instructions to add the new object representation to the simulation of the external environment, the new object representation corresponding to a real-world counterpart in the external environment characterized, at least in part, by the data collected by at least one sensor of the agent.

7. The method of claim 1, further comprising:
providing additional data collected by at least one sensor of the agent to the at least one user of the tele-operation system;
receiving additional simulation instructions from the at least one user of the tele- operation system;
re-updating the simulation of the external environment based on the additional simulation instructions; and
displaying the re-updated simulation of the external environment to the at least one user of the tele-operation system.

8. The method of claim 1 wherein the agent includes a robot system including a robot body and the at least one sensor of the agent includes at least one image sensor on-board the robot body, and wherein:
displaying a simulation of the external environment of the agent to at least one user of the tele-operation system includes displaying a simulation of the external environment of the robot body to at least one user of the tele-operation system;
receiving data collected by at least one sensor of the agent includes receiving data collected by at least one image sensor of the robot body; and
providing the data collected by at least one sensor of the agent to the at least one user of the tele-operation system includes providing the data collected by at least one image sensor of the robot body to the at least one user of the tele-operation system.

9. The method of claim 8, further comprising:
training the robot system to autonomously update the simulation of the external environment based on multiple iterations of:
the receiving data collected by at least one image sensor of the robot body;
the providing the data collected by at least one image sensor of the robot body to the at least one user of the tele-operation system
the receiving simulation instructions from the at least one user of the tele-operation system based at least in part on the data collected by at least one image sensor of the robot body; and
the updating the simulation of the external environment based on the simulation instructions.

10. The method of claim 8 wherein the at least one user of the tele-operation system includes at least one tele-operator of the robot system.

11. The method of claim 1 wherein the at least one user of the tele-operation system includes a plurality of tele-artists and the tele-operation system enables the plurality of tele-artists to concurrently update the simulation.

12. A tele-operation system comprising:
at least one processor; and
at least one non-transitory processor-readable storage medium communicatively coupled to the at least one processor, the at least one non-transitory processor-readable storage medium storing data and/or processor-executable instructions that, when executed by the at least one processor, cause the tele-operation system to:
display a simulation of an external environment of an agent to at least one user of the tele-operation system, the at least one user being physically remote from the agent;
receive data collected by at least one sensor of the agent;
provide the data collected by at least one sensor of the agent to the at least one user of the tele-operation system;
receive simulation instructions from the at least one user of the tele-operation system based at least in part on the data collected by at least one sensor of the agent;
update the simulation of the external environment based on the simulation instructions; and
display the updated simulation of the external environment to the at least one user of the tele-operation system.

13. The tele-operation system of claim 12 wherein the processor-executable instructions that, when executed by the at least one processor, cause the tele-operation system to receive simulation instructions from the at least one user of the tele-operation system, cause the tele-operation system to receive instructions that describe a modification to the simulation of the external environment, and wherein the processor-executable instructions that, when executed by the at least one processor, cause the tele-operation system to update the simulation of the external environment based on the simulation instructions, cause the tele-operation system to apply the modification to the simulation of the external environment to cause the simulation of the external environment to more closely match a reality of the external environment.

14. The tele-operation system of claim 12 wherein the processor-executable instructions that, when executed by the at least one processor, cause the tele-operation system to receive simulation instructions from the at least one user of the tele-operation system, cause the tele-operation system to receive instructions that describe a modification to at least one object representation in the simulation of the external environment, and wherein the processor-executable instructions that, when executed by the at least one processor, cause the tele-operation system to update the simulation of the external environment based on the simulation instructions, cause the tele-operation system to apply the modification to at least one object representation in the simulation of the external environment to cause the at least one object representation to more closely resemble a corresponding real-world counterpart object in the external environment.

15. The tele-operation system of claim 12 wherein the agent includes a robot system including a robot body, and the at least one sensor of the agent includes at least one image sensor on-board the robot body.

16. The tele-operation system of claim 15, further comprising:
data and/or processor-executable instructions stored in the non-transitory processor-readable storage medium that, when executed by the at least one processor, cause the tele-operation system to:
train the robot system to autonomously update to the simulation of the external environment based on multiple iterations of:
receiving simulation instructions from the at least one user of the tele-operation system based at least in part on the data collected by at least one image sensor of the robot body; and
updating the simulation of the external environment based on the simulation instructions.

17. The tele-operation system of claim 12 wherein the at least one user of the tele-operation system includes a plurality of tele-artists and the tele-operation system enables the plurality of tele-artists to concurrently update the simulation.

18. A computer program product comprising data and/or processor-executable instructions stored in a non-transitory processor-readable storage medium, the data and/or processor-executable instructions which, when the non-transitory processor-readable storage medium is communicatively coupled to at least one processor of a tele-operation system and the at least one processor executes the data and/or processor-executable instructions, cause the tele-operation system to:
display a simulation of an external environment of an agent to at least one user of the tele-operation system, the at least one user being physically remote from the agent;
receive data collected by at least one sensor of the agent;
provide the data collected by at least one sensor of the agent to the at least one user of the tele-operation system;
receive simulation instructions from the at least one user of the tele-operation system based at least in part on the data collected by at least one sensor of the agent;
update the simulation of the external environment based on the simulation instructions; and
display the updated simulation of the external environment to the at least one user of the tele-operation system.

19. The computer program product of claim 18 wherein the at least one user of the tele-operation system includes a plurality of tele-artists and the computer program product enables the plurality of tele-artists to concurrently update the simulation through the tele-operation system.

20. The computer program product of claim 18, wherein the agent includes a robot system including a robot body and the at least one sensor of the agent includes at least one image sensor on-board the robot body, and further comprising:
data and/or processor-executable instructions which, when the non-transitory processor-readable storage medium is communicatively coupled to at least one processor of a tele-operation system and the at least one processor executes the data and/or processor-executable instructions, cause the tele-operation system to:
train the robot system to autonomously update the simulation of the external environment based on multiple iterations of:
receiving simulation instructions from the at least one user of the tele-operation system based at least in part on the data collected by at least one image sensor of the robot body; and
updating the simulation of the external environment based on the simulation instructions.
